(19) United States
(12) Patent Application Publication
(10) Pub. No.: US 2018/0368152 A1
(43) Pub. Date: Dec. 20, 2018

(54) Method for Simultaneous Beam Administration and Data Transmission in Beamforming Wireless Systems

(71) Applicant: MEDIATEK INC., Hsinchu (TW)

(72) Inventors: Hsuan-Li Lin, Hsinchu (TW); Ming-Po Chang, Hsinchu (TW); Chia-Hao Yu, Hsinchu (TW); Jiann-Ching Guey, Hsinchu (TW)

(21) Appl. No.: 16/006,925

(22) Filed: Jun. 13, 2018

Related U.S. Application Data
(60) Provisional application No. 62/520,626, filed on Jun. 16, 2017.

(51) Int. Cl. H04W 72/08; H04J 3/16; H04L 5/00

(52) U.S. Cl. CPC H04W 72/085; H04J 3/1694; H04L 5/0053; H04L 5/0051; H04L 5/0023

(57) ABSTRACT

A method of configuring and applying UE beam training gaps for simultaneous UE beam training and data reception in a beamforming wireless communication system is proposed. UE beam training gaps are configured by the base station for each UE. Typically, UE-specific data transmission can take place during the serving control beam time region. The UE beam training gaps are periods where UE-specific data transmission does not happen within the serving control beam time region. During each UE beam training gap, non-serving UE beam training can take place, where the UE performs intra-frequency reference signal measurements from serving and/or neighbor cells using various non-serving UE beams. The UE beam training gaps are configured and signaled to each UE, and each individual UE can have different data occupancy region within its serving CB time region.

### CROSS REFERENCE TO RELATED APPLICATIONS

This application claims priority under 35 U.S.C. § 119 from U.S. Provisional Application No. 62/520,626, entitled “Method for Simultaneous Beam Administration and Data,” filed on Jun. 16, 2017; the subject matter of which is incorporated herein by reference.

### TECHNICAL FIELD

The disclosed embodiments relate generally to wireless communication, and, more particularly, to simultaneous beam administration and data transmission in a Millimeter Wave (mmWave) beamforming system.

### BACKGROUND

The bandwidth shortage increasingly experienced by mobile carriers has motivated the exploration of the underutilized Millimeter Wave (mmWave) frequency spectrum between 3G and 300G Hz for the next generation broadband cellular communication networks. The available spectrum of mmWave band is two hundred times greater than the conventional cellular system. The mmWave wireless network uses directional communications with narrow beams and can support multi-gigabit data rate. The underutilized bandwidth of the mmWave spectrum has wavelengths ranging from 1 mm to 100 mm. The very small wavelengths of the mmWave spectrum enable large number of miniaturized antennas to be placed in a small area. Such miniaturized antenna system can produce high beamforming gains through electrically steerable arrays generating directional transmissions.

With recent advances in mmWave semiconductor circuitry, mmWave wireless system has become a promising solution for real implementation. However, the heavy reliance on directional transmissions and the vulnerability of the propagation environment present particular challenges for the mmWave network. In general, a cellular network system is designed to achieve the following goals: 1) Serve many users with widely dynamical operation conditions simultaneously; 2) Robust to the dynamics in channel variation, traffic loading and different QoS requirement; and 3) Efficient utilization of resources such as bandwidth and power. Beamforming adds to the difficulty in achieving these goals.

In principle, beam training mechanism, which includes both initial beam alignment and subsequent beam tracking, ensures that base station (BS) beam and user equipment (UE) beam are aligned for data communication. In downlink DL-based beam management, the BS side provides opportunities for UE to measure beamformed channel of different combinations of BS beams and UE beams. For example, BS performs periodic beam sweeping with reference signal (RS) carried on individual BS beams. UE can collect beamformed channel state by using different UE beams and report the collect information to BS.

With control beam (CB) transmission from the BS, the transmission pattern is known or can be learned by the UE. Before the UE establishes connection, reference signal transmitted by control beams can all be used for beam training. After the UE establishes connection, it is inevitable to have at least some dedicated control channels to be carried as well, during or after the BS-UE connection is being or has been established. Control beam is the only communication means before dedicated beam is further trained. Some low-load data may also be carrier by control beam. Control beam also provides robust fallback beam when dedicated beam loses track. Beam training and UE-specific data reception can conflict if UE RX beam training relies on control beam transmission, especially when UE has only one RF transceiver.

For simultaneous beam training and UE-specific data transmission, a solution is sought to resolve such conflict and to prevent data loss.

### SUMMARY

A method of configuring and applying UE beam training gaps for simultaneous UE beam training and data reception in a beamforming wireless communication system is proposed. UE beam training gaps are configured by the base station for each UE. Typically, UE-specific data transmission can take place during the serving control beam time region. The UE beam training gaps are periods where UE-specific data transmission does not happen within the serving control beam time region. During each UE beam training gap, non-serving UE beam training can take place, where the UE performs intra-frequency reference signal measurements from serving and/or neighbor cells using various non-serving UE beams. The UE beam training gaps are configured and signaled to each UE, and each individual UE can have different data occupancy region within its serving CB time region.

In one embodiment, a user equipment (UE) establishes a radio resource control (RRC) connection with the base station in a beamforming wireless communication network. The UE receives reference signals over a plurality of TX control beams (CBs) using a plurality of UE RX beams. Each control beam is associated with a beamforming weight and occupies periodic CB time regions. The UE receives UE-specific data from a serving CB using a chosen UE RX beam during periodic serving CB time regions. The UE performs beam training and data reception during the serving CB time regions. The serving CB time regions are divided into UE beam training gaps for beam training and data occupancy regions for data reception.

In another embodiment, a BS establishes a radio resource control (RRC) connection with a user equipment (UE) in a beamforming wireless communication network. The BS transmits reference signals using a plurality of TX control beams (CBs). Each control beam is associated with a beamforming weight and occupies periodic CB time regions. The BS transmits UE-specific data using a serving CB during periodic serving CB time regions. The BS provides beam training configuration to the UE. The serving CB time regions are divided into UE beam training gaps for UE beam training and data occupancy regions for UE data reception.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a Millimeter Wave beamforming wireless communication system with simultaneous beam administration and data transmission in accordance with one novel aspect.

FIG. 2 is a simplified block diagram of a base station and a user equipment that carry out certain embodiments of the present invention.

FIG. 3 illustrates a first embodiment of UE beam training gap configuration in accordance with one novel aspect.

FIG. 4 illustrates a second embodiment of UE beam training gap configuration in accordance with one novel aspect.

FIG. 5 illustrates an example of sequence flow between a UE and a base station for simultaneous UE beam training and data reception.

FIG. 6 illustrates examples of simultaneous UE beam training and data reception with different embodiments of UE beam training gaps.

FIG. 7 is a flow chart of applying UE beam training gaps from user equipment perspective for simultaneous UE beam training and data reception in accordance with one novel aspect.

FIG. 8 is a flow chart of configuring UE beam training gaps from base station perspective for simultaneous UE beam training and data reception in accordance with one novel aspect.

### DETAILED DESCRIPTION

Reference will now be made in detail to some embodiments of the invention, examples of which are illustrated in the accompanying drawings.

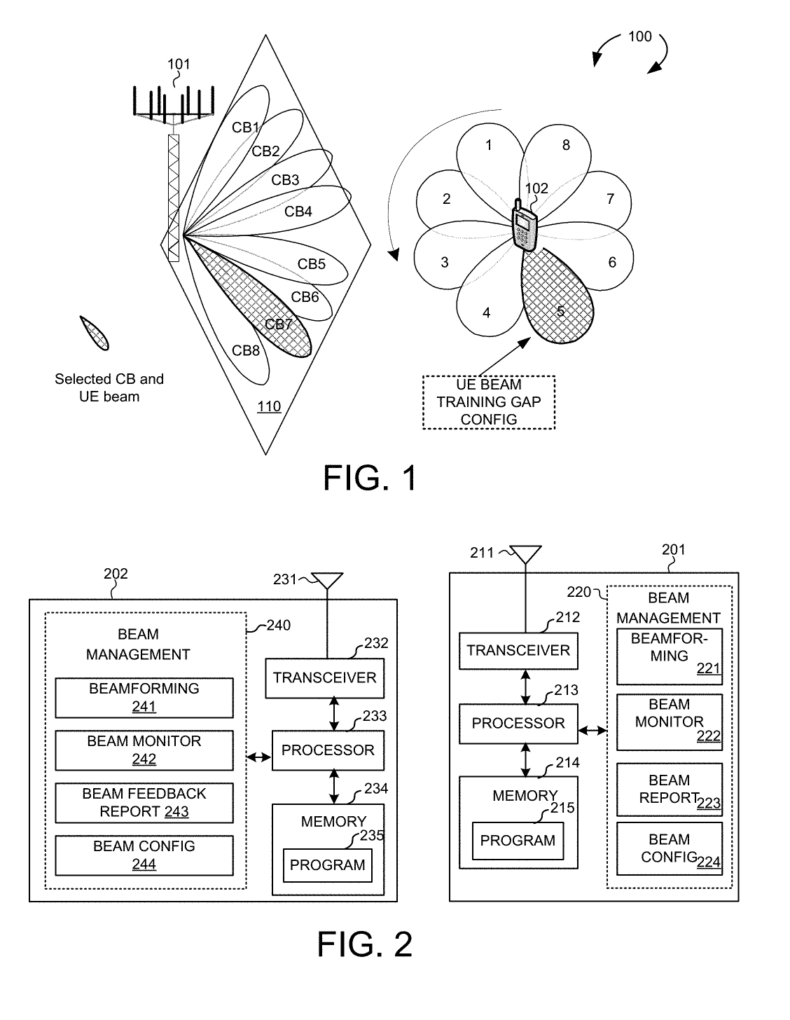

FIG. 1 illustrates a Millimeter Wave beamforming wireless communication system 100 with simultaneous beam administration and data transmission in accordance with one novel aspect. Beamforming mmWave mobile communication network 100 comprises a base station BS 101 and a user equipment UE 102. The mmWave cellular network uses directional communication with narrow beams and can support multi-gigabit data rate. Directional communication is achieved via digital and/or analog beamforming, wherein multiple antenna elements are applied with multiple sets of beamforming weights to form multiple beams. Different beamformers can have different spatial resolution, i.e., beamwidth. For example, a sector antenna can form beams having lower array gain but wider spatial coverage, while a beamforming antenna can have higher array gain but narrower spatial coverage.

In the example of FIG. 1, BS 101 is directionally configured with multiple cells, and each cell is covered by a set of coarse TX/RX control beams. For example, cell 110 is covered by a set of eight control beams CB1 to CB8. The collection of the control beams CB1-CB8 covers an entire service area of cell 110, and each control beam has a wider and shorter spatial coverage as depicted. Each control beam in turn is covered by a set of dedicated data beams, and each dedicated data beam has a narrower and longer spatial coverage. The control beam and dedicated data beam architecture provides a robust control-signaling scheme to facilitate the beamforming operation in mmWave cellular network systems.

A base station broadcasts reference signals in control channels with spatial-domain control beam pattern for cell search and handover applications. The set of control beams are lower-level beams that provide low rate control signaling to facilitate high rate data communication on higher-level data beams. The set of control beams may be periodically configured or occur indefinitely and repeatedly in order known to the UEs. Each control beam broadcasts minimum amount of cell-specific and beam-specific information similar to System Information Block (SIB) or Master Information Block (MIB) in LTE systems, or synchronization signal block (SSB) in 5G systems. Each control beam may also carry UE-specific control or data traffic. Each control beam transmits a set of known reference signals for the purpose of initial time-frequency synchronization, identification of the control beam that transmits the reference signals, and measurement of radio channel quality for the control beam that transmits the reference signals.

In principle, beam training mechanism, which includes both initial beam alignment and subsequent beam tracking, ensures that BS beam and UE beam are aligned for data communication. In downlink DL-based beam management, the BS side provides opportunities for UE to measure beamformed channel of different combinations of BS TX beams CB1-CB8 and UE RX beams 1-8. For example, BS performs periodic beam sweeping with reference signal (RS) carried on individual BS TX beams. UE can collect beamformed channel state by using different UE RX beams and report the collected information to BS.

With control beam (CB) transmission from the BS, the transmission pattern is known or can be learned by the UE. Before the UE establishes connection, reference signal transmitted by control beams can all be used for beam training. After the UE establishes connection, it is inevitable to have at least some dedicated control channels to be carried as well, during or after the BS-UE connection is being for has been established. Control beam is the only communication means before dedicated beam is further trained. Some low-load data may also be carrier by control beam. Control beam also provides robust fallback beam when dedicated beam loses track. Beam training and data reception conflicts if UE RX beam training relies on control beam transmission, especially when UE has only one RF transceiver.

In the example of FIG. 1, CB7 is the selected serving control beam and UE beam#5 is the selected UE beam. Since control beams (CB1-CB8) are time-domain multiplexed, training between non-serving control beams and all UE beams does not affect data transmission. Training between serving CB7 and selected UE beam#5 can operate at the same time as data transmission via serving CB7. However, training between serving CB7 and non-serving UE beams is very likely to cause data loss. The channel between serving CB7 and non-serving UE beams may be too weak for proper data reception. Therefore, when UE has a single transceiver, and UE beam training is required based on CB transmission, conflict occurs when reference signals and UE-specific data take place at the same time slot with the same transmit beam.

In according with one novel aspect, UE-specific transmission should not occupy the entire time span of its serving CB. Specifically, UE is in RRC connected state with dedicated date scheduled on its serving CB. As a result, the training pilot and the dedicated data may take place at the same time slot. To prevent data loss, UE-specific dedicated data transmission occupies only part of its serving CB time span, preferably the occupancy is contiguous in time. A UE beam training gap is created for UE, it is a period where UE-specific transmission does not happen within the serving CB time span, during which non-serving UE beam training can take place. The UE beam training gap is configured and signaled to each UE, and each individual UE can have different data occupancy region within its serving CB time span.

FIG. 2 is a simplified block diagram of a base station and a user equipment that carry out certain embodiments of the present invention. BS 201 has an antenna array 211 having multiple antenna elements that transmits and receives radio signals, one or more RF transceiver modules 212, coupled with the antenna array, receives RF signals from antenna 211, converts them to baseband signal, and sends them to processor 213. RF transceiver 212 also converts received baseband signals from processor 213, converts them to RF signals, and sends out to antenna 211. Processor 213 processes the received baseband signals and invokes different functional modules to perform features in BS 201. Memory 214 stores program instructions and data 215 to control the operations of BS 201. BS 201 also includes multiple function modules that carry out different tasks in accordance with embodiments of the current invention.

Similarly, UE 202 has an antenna 231, which transmits and receives radio signals. A RF transceiver module 232, coupled with the antenna, receives RF signals from antenna 231, converts them to baseband signals and sends them to processor 233. RF transceiver 232 also converts received baseband signals from processor 233, converts them to RF signals, and sends out to antenna 231. Processor 233 processes the received baseband signals and invokes different functional modules to perform features in UE 202. Memory 234 stores program instructions and data 235 to control the operations of UE 202. UE 202 also includes multiple function modules and circuits that carry out different tasks in accordance with embodiments of the current invention.

The functional modules and circuits can be implemented and configured by hardware, firmware, software, and any combination thereof. For example, BS 201 comprises a beam management module 220, which further comprises a beamforming circuit 221, a beam monitor 222, a beam reporting circuit 223, and a beam training configuration circuit 224. Beamforming circuit 221 may belong to part of the RF chain, which applies various beamforming weights to multiple antenna elements of antenna 211 and thereby forming various beams. Beam monitor 222 monitors received radio signals and performs measurements of the radio signals over the various UE beams. Beam reporting circuit 223 reports the beam monitoring results for each received UE beam. Beam training configuration circuit 224 configures beam training gap to UEs for simultaneous UE beam training and UE data reception.

Similarly, UE 202 comprises a beam management module 240, which further comprises a beamforming circuit 241, a beam monitor 242, a beam feedback circuit 243, and a beam training configuration circuit 244. Beamforming circuit 241 may belong to part of the RF chain, which applies various beamforming weights to multiple antenna elements of antenna 231 and thereby forming various beams. Beam monitor 242 monitors received radio signals and performs measurements of the radio signals over the various beams. Beam feedback circuit 243 provide beam quality metric and send report to BS 201 based on the beam monitoring results for each BS beam. Beam training configuration circuit 244 receives beam training configuration from BS 201 and performs beam training and UE-specific data transmission in allocated time accordingly.

In one novel aspect, UE beam training gaps are configured by the base station for each UE. Typically, UE-specific data transmission can take place during the serving CB time region. The UE beam training gaps are periods where UE-specific data transmission does not happen within the serving CB time region. During each UE beam training gap, non-serving UE beam training can take place, where the UE performs intra-frequency reference signal measurements from serving and/or neighbor cells using various non-serving UE beams. The UE beam training gaps are configured and signaled to each UE, and each individual UE can have different data occupancy region within its serving CB time region.

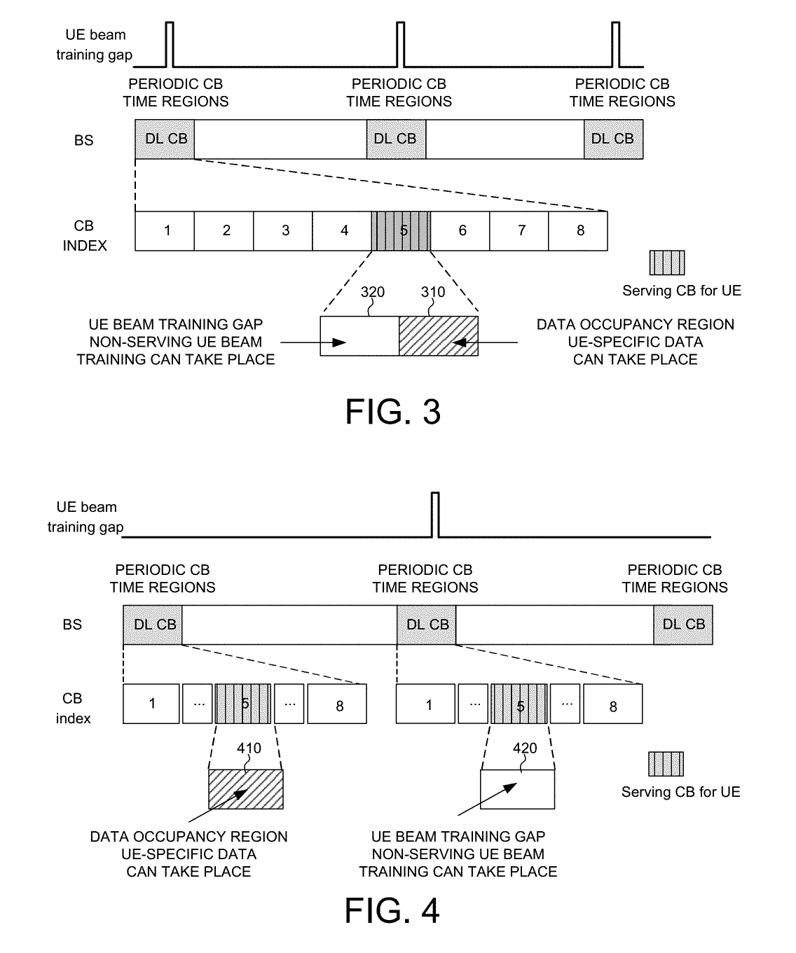

FIG. 3 illustrates a first embodiment of UE beam training gap configuration in accordance with one novel aspect. As a general concept, a downlink control beam (DL CB) is defined as a set of time-frequency resource blocks in which the base station uses the same beamforming weights set for its downlink transmission to the receiving UEs. The said time-frequency resource blocks, referred to as downlink control resource blocks, may be periodically configured in order known to the UEs. Each periodically occurred DL CB region comprises different CBs that are time division multiplexed (TDM) in time domain, e.g., DL CB0 to DL CB8. The DL CBs are used to carry cell and beam identification, synchronization, cell-specific and beam-specific broadcast, and UE-specific control and UE-specific data transmission.

In the embodiment of FIG. 3, DL CB5 is the serving DL CB for a receiving UE. The UE-specific data transmission takes place during the periodically occurred serving DL CB5 time regions, when UE performs data reception using a selected UE receive beam. However, to facilitate intra-frequency measurements, e.g., beam training involving other non-chosen UE receive beams, the UE-specific data transmission should not occupy the entire time span of each serving DL CB5 time region. In this embodiment, each serving DL CB5 time region is divided into two parts, a first part is allocated for UE-specific data, and a second part is allocated for non-chosen UE beam training. The first part is referred to as the data occupancy region, where the UE receives dedicated data using the selected UE beam. The second part is referred to as the UE beam training gap, where the UE performs reference signal measurements by switching to other non-chosen UE beams. Preferably, each data occupancy region (e.g., 310) is contiguous in time within each CB5 time region, and each UE beam training gap (e.g., 320) has a gap length that is less than the time length of the serving DL CB5 time region.

FIG. 4 illustrates a second embodiment of UE beam training gap configuration in accordance with one novel aspect. The DL CB configuration of FIG. 4 is the same as in FIG. 3. Similarly, DL CB5 is the serving DL CB for a receiving UE. The UE-specific data transmission takes place during the periodically occurred serving DL CB5 time regions, when UE performs data reception using a selected UE receive beam. However, to facilitate intra-frequency measurements, e.g., beam training involving other non-chosen UE receive beams, the UE-specific data transmission should not occupy the entire time span of each serving DL CB5 time region.

In the embodiment of FIG. 4, a first subset of DL CB5 time regions is allocated for UE-specific data, and a second subset of DL CB5 time regions is allocated for non-chosen UE beam training. The first subset is referred to as the data occupancy region, where the UE receives dedicated data using the selected UE beam. The second subset is referred to as the UE beam training gap, where the UE performs reference signal measurements by switching to other non-chosen UE beams. Preferably, each data occupancy region (e.g., 410) is contiguous in time within each CB time region, and each UE beam training gap (e.g., 420) has a gap length that is equal to or larger than the time length of multiple time spans of each control beam time region.

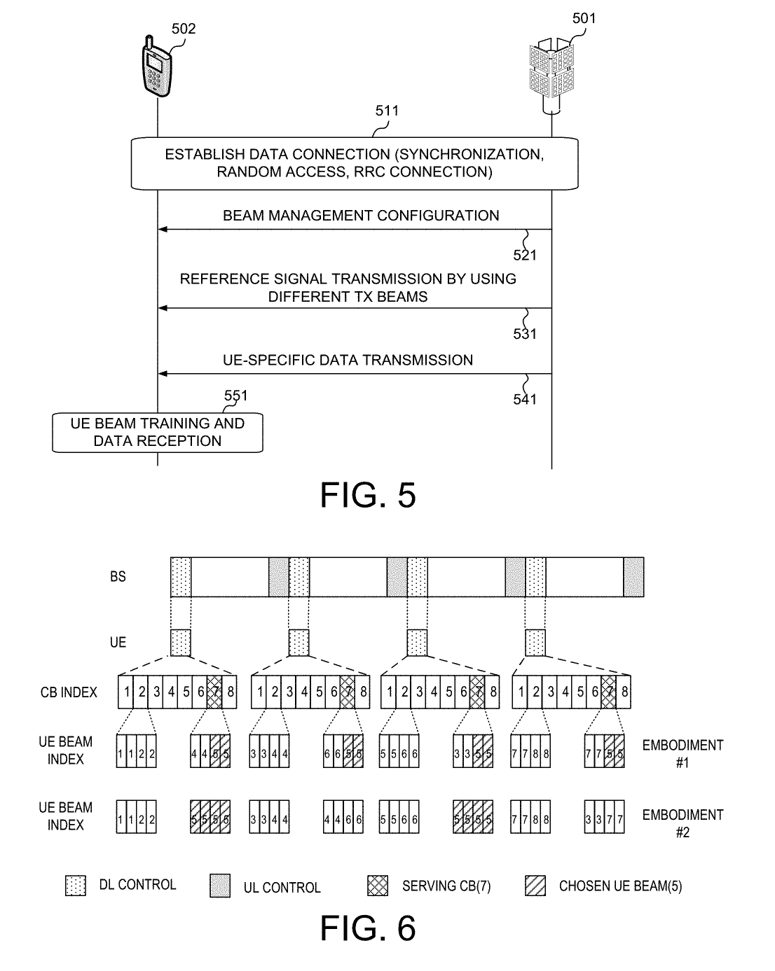

FIG. 5 illustrates an example of sequence flow between a UE and a base station for simultaneous UE beam training and data reception. In step 511, UE 502 establishes a dedicated RRC connection with its serving BS 501 after performing synchronization and random-access procedure. Upon the RRC connection, UE 501 knows the serving CB and the selected UE beam. UE 501 can receive UE-specific data over the serving CB using the chosen UE receive beam. In step 521, BS 501 provides beam management configuration to UE 502. The beam management configuration comprises beam training configuration, e.g., beam training gap and/or data occupancy region signaling. For example, the periodicity and the time length of the UE beam training gap can be signaled. Equivalently, UE can learn such beam training gap information on occupancy. Note that the concept of UE beam training gap is similar to LTE measurement gap. For inter-frequency measurement, UE-specific transmission should not occupy during the measurement gap. However, on top of the measurement gap, UE needs the beam training gap when the training pilot (reference signal) and UE-specific data could take place at the same time slot.

In step 531, UE 502 receives reference signal transmission over different CBs using different UE receive beams for beam training. In step 541, UE 502 receives UE-specific data from BS 501 over its serving CB using the chosen UE receive beam. Since control beams are time-domain multiplexed, training between non-serving control beams and all UE beams does not affect data transmission. Training between serving CB and serving UE beam can operate at the same time as data transmission via the serving CB. However, training between serving CB and non-serving UE beams is very likely to cause data loss. The channel between serving CB and non-serving UE beams may be too weak for proper data reception. To prevent data loss, in step 551, UE 502 performs beam training and data reception based on the configured UE beam training gap. The UE beam training gap provides a period where UE-specific data should not occupy during the serving CB time region and non-serving UE beam training can take place. UE 502 can switch to other non-serving UE beams and measure intra-frequency reference signals from the serving cell as well as from neighboring cells.

FIG. 6 illustrates examples of simultaneous UE beam training and data reception with different embodiments of UE beam training gaps. In the example of FIG. 6, the BS is configured with 8 control beams CB1-CB8, and CB7 is the serving CB. The UE also has 8 UE receive beams 1-8, and UE beam 5 is the selected UE receive beam. During non-serving CB time regions, e.g., CB2 time region, the UE can use any of the RX beams for the entire time span to perform beam training. However, during the serving CB7 time region, the UE can only use part of the time span to perform data reception using UE beam 5 (data occupancy region), and reserve other part of the time span to perform non-chosen UE beam training (UE beam training gap). In a first embodiment #1, each CB7 time region is split into two parts, the first part is the UE beam training gap and the second part is the data occupancy region. In a second embodiment #2, some CB7 time region is used for non-chosen UE beam training, and some CB7 time region is used for UE data transmission.

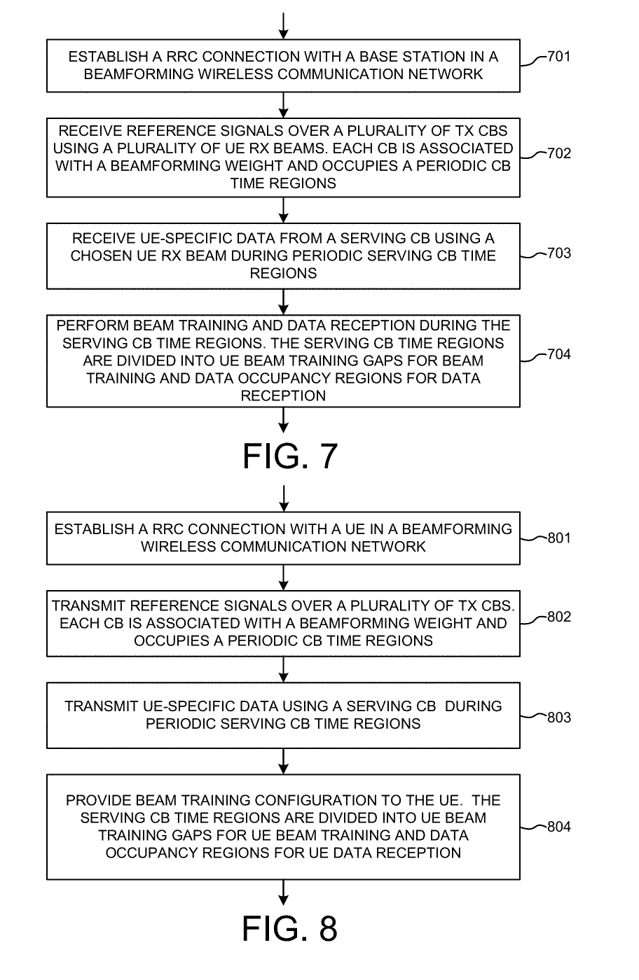

FIG. 7 is a flow chart of applying UE beam training gaps from user equipment perspective for simultaneous UE beam training and data reception in accordance with one novel aspect. In step 701, a UE establishes a radio resource control (RRC) connection with the base station in a beamforming wireless communication network. In step 702, the UE receives reference signals over a plurality of TX control beams (CBs) using a plurality of UE RX beams. Each control beam is associated with a beamforming weight and occupies periodic CB time regions. In step 703, the UE receives UE-specific data from a serving CB using a chosen UE RX during periodic serving CB time regions. In step 704, the UE performs beam training and data reception during the serving CB time regions. The serving CB time regions are divided into UE beam training gaps for beam training and data occupancy regions for data reception.

FIG. 8 is a flow chart of configuring UE beam training gaps from base station perspective for simultaneous UE beam training and data reception in accordance with one novel aspect. In step 801, a BS establishes a radio resource control (RRC) connection with a user equipment (UE) in a beamforming wireless communication network. In step 802, the BS transmits reference signals using a plurality of TX control beams (CBs). Each control beam is associated with a beamforming weight and occupies periodic CB time regions. In step 803, the BS transmits UE-specific data using a serving CB during periodic serving CB time regions. In step 804, the BS provides beam training configuration to the UE. The serving CB time regions are divided into UE beam training gaps for UE beam training and data occupancy regions for UE data reception.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
establishing a radio resource control (RRC) connection with the base station by a user equipment (UE) in a beamforming wireless communication network;
receiving reference signals over a plurality of TX control beams (CBs) using a plurality of UE RX beams, wherein each control beam is associated with a beamforming weight and occupies periodic CB time regions;
receiving UE-specific data from a serving CB using a chosen UE RX beam during periodic serving CB time regions; and
performing beam training and data reception during the serving CB time regions, wherein the serving CB time regions are divided into UE beam training gaps for beam training and data occupancy regions for data reception.

2. The method of claim 1, wherein each CB time region of the plurality of TX CBs are Time Division Multiplexed (TDM) and contiguous in time domain.

3. The method of claim 1, wherein the beam training involves intra-frequency measurements using a non-serving UE RX beam during the beam training gaps.

4. The method of claim 3, wherein each of the serving CB regions is divided to comprise a UE beam training gap and a data occupancy region.

5. The method of claim 3, wherein a first subset of the serving CB regions is configured as the UE beam training gaps, and a second subset of the serving CB regions is configured as the data occupancy regions.

6. The method of claim 1, wherein the UE obtains implicit signaling of pre-determined mapping of the UE data occupancy regions and the UE beam training gaps.

7. The method of claim 1, wherein the UE receives explicit signaling from the base station indicating the UE beam training gaps.

8. A user equipment (UE), comprising:
a configuration circuit that establishes a radio resource control (RRC) connection with the base station in a beamforming wireless communication network;
a radio frequency (RF) receiver that receives reference signals over a plurality of TX control beams (CBs) using a plurality of UE RX beams, wherein each control beam is associated with a beamforming weight and occupies periodic CB time regions;
the RF receiver that receives UE-specific data from a serving CB using a chosen UE RX beam during periodic serving CB time regions; and
a beam monitoring circuit that performs beam training and data reception during the serving CB time regions, wherein the serving CB time regions are divided into UE beam training gaps for beam training and data occupancy regions for data reception.

9. The UE of claim 8, wherein each CB time region of the plurality of TX CBs are Time Division Multiplexed (TDM) and contiguous in time domain.

10. The UE of claim 8, wherein the beam training involves intra-frequency measurements using a non-serving UE RX beam during the beam training gaps.

11. The UE of claim 10, wherein each of the serving CB regions is divided to comprise a UE beam training gap and a data occupancy region.

12. The UE of claim 10, wherein a first subset of the serving CB regions is configured as the UE beam training gaps, and a second subset of the serving CB regions is configured as the data occupancy regions.

13. The UE of claim 8, wherein the UE obtains implicit signaling of pre-determined mapping of the UE data occupancy regions and the UE beam training gaps.

14. The UE of claim 8, wherein the UE receives explicit signaling from the base station indicating the UE beam training gaps.

15. A method, comprising:
establishing a radio resource control (RRC) connection with a user equipment (UE) by a base station in a beamforming wireless communication network;
transmitting reference signals using a plurality of TX control beams (CBs), wherein each control beam is associated with a beamforming weight and occupies periodic CB time regions;
transmitting UE-specific data using a serving CB during periodic serving CB time regions; and
providing beam training configuration to the UE, wherein the serving CB time regions are divided into UE beam training gaps for UE beam training and data occupancy regions for UE data reception.

16. The method of claim 15, wherein each CB time region of the plurality of TX CBs are Time Division Multiplexed (TDM) and contiguous in time domain.

17. The method of claim 15, wherein the UE beam training involves intra-frequency measurements using a non-serving UE RX beam during the UE beam training gaps.

18. The method of claim 17, wherein each of the serving CB regions is divided to comprise a UE beam training gap and a data occupancy region.

19. The method of claim 17, wherein a first subset of the serving CB regions is configured as the UE beam training gaps, and a second subset of the serving CB regions is configured as the data occupancy regions.

20. The method of claim 15, wherein the base station provides implicit signaling of pre-determined mapping of the UE data occupancy regions and the UE beam training gaps.

21. The method of claim 15, wherein the base station transmits explicit signaling indicating the UE beam training gaps.
